(19) United States
(12) Patent Application Publication
(10) Pub. No.: US 2004/0098594 A1
(43) Pub. Date: May 20, 2004

(54) System and method for creating role-based access profiles

(76) Inventors: Richard Hugh Fleming, Huntersville, NC (US); Winona Whitener, Rock Hill, SC (US); David Scott Standeven, Plano, TX (US); Jay A. Watson, Anioch, CA (US); William Jeffrey Moonly, Denver, NC (US); Russell Tyrone Fair, Charlotte, NC (US)

Correspondence Address: MOORE & VAN ALLEN, PLLC, 2200 W MAIN STREET, SUITE 800, DURHAM, NC, 27705, US

(21) Appl. No.: 10/065,741

(22) Filed: Nov. 14, 2002

(51) Int. Cl. H04L 9/00

(52) U.S. Cl. 713/182

(57) ABSTRACT

System and method for creating role-based access profiles. Role-based access profiles are created from information about existing access groups for computer resources within an enterprise. In some embodiments, a user accesses a list of associates for potential use in modeling the access rights for a role. The user makes a selection of associates from the list to use in modeling access rights. These are referred to as “model associates”. Existing membership of the model associates in access groups related to computer resources is evaluated and an access profile is produced based on that evaluation.

### BACKGROUND OF INVENTION

Access to modern computer systems and information networks, especially within an enterprise, is almost always controlled to meet the security needs of the organization using the system. Access control is typically accomplished using access rights which determine whether and how individual users may access data, whether that data is on an individual computer system, or spread across a plurality of related computer resources. In many systems, access rights are granted or revoked explicitly for individual users or groups of users with respect to specific servers, programs, or objects. In some cases an individual computer resource includes an access control list (ACL) associated with the computer resource, or a specific program that is part of the computer resource. When an access request occurs during operation of the computer system in question, the security function in the computer system, typically within the operating system, looks at the access control list and decides whether the user may access the resource in the requested manner.

The above methodology has worked well as long as individual servers or small networks are involved. As large enterprises have acquired more and more computer resources, however, dealing with the large numbers of users and computer resources solely in this manner has become administratively cumbersome. In order to alleviate this administrative burden, role-based access control (RBAC) has been developed. With RBAC, access to a computer resource within a server or a network is provided to members of one or more groups who are assigned a certain role. All users or associates belonging to a given role have the same privileges to access various objects within a system. Individuals are granted access to objects by being assigned membership in appropriate roles. RBAC is considered useful in many commercial environments because it allows access to computing resources to be conveniently organized along lines corresponding to the actual duties and responsibilities of individuals in an organization.

Role-based access control has been extensively studied and written about. It has found use in some organizations in recent years. However, adoption of RBAC has been limited by the time and overhead required to migrate an enterprise from traditional access control to role-based access control.

### SUMMARY OF INVENTION

The present invention provides a method and system for creating role-based access profiles based on existing, known, access groups for computer resources within an enterprise. An automated tool, according to embodiments of the invention, can be used internally by an organization responsible for information technology (IT) or corporate information security, or by an external consultant. Persons who are being grouped into roles are referred to herein as associates to distinguish them from a user of the automated tool according to embodiments of the invention. Associates can be assigned one or more roles and each role is assigned privileges, as is typical of an RBAC based system. Access profiles are developed at the broadest level possible, granting access on a need-to-withhold basis instead of the need-to-know basis that is effectively used in traditional access control.

According to some embodiments of the invention, a role-based access profile for a plurality of related computer resources is created by first accessing a list of associates for potential use in modeling the potential access rights for such a role. A user of the tool makes a selection of associates from the list to use in modeling access rights. These are referred to as “model associates”. Existing membership of the model associates in access groups related to the computer resources is evaluated and the access profile is produced based on that evaluation of the existing membership of the model associates in the access groups. The access profile corresponds to a new role.

In some embodiments, existing membership in access groups is evaluated by determining whether a commonality of membership in each specific access group at least meets a specific threshold value. The threshold value can be programmed into the software tool or input by the user. In some embodiments, this threshold value is a minimum percentage of associates who have or who are in a given access group. Based on the groups that the associates are members of with a common membership that meets or exceeds the threshold, existing access groups are included in the new role and a profile for the role is created. This creation of the profile can be completely automated, or the groups to be included can be recommended to a user, who then can modify the selection. In some embodiments, associates are initially picked from a list which is produced after receiving certain search parameters from a user, for example, hierarchy code parameters which are related to the structure of the enterprise.

The method of the invention is typically implemented on a computer system running a computer program product. A database of access group information and any other information, tables, or data structures that are needed or created by the tool is maintained. This database can either be stored on the computer system that executes the tool, or it can be accessed over a network connection. In any case, in some embodiments, the database is updated via a network connection to other resources within the enterprise. These resources may include security administration databases, or access control lists at each individual computer resource.

When a new role-based access profile is created, it can be stored locally, forwarded to administrative personnel for review, or possibly implemented automatically. Automated implementation may involve writing the new information directly to a security administration database or databases, or other computing resources within the enterprise. In any case, the computer program product, processing platform, databases, and other hardware and software used to implement the invention form the means for carrying out the processes of the specific embodiments disclosed. The system of the invention is sometimes referred to herein as a profile access selection system or PASS.

### BRIEF DESCRIPTION OF DRAWINGS

FIG. 1 is a flowchart illustrating the overall process according to some embodiments of the invention.

FIG. 2 is a network block diagram illustrating the operating environment of embodiments of the invention.

FIG. 3 is a more detailed flowchart of certain aspects of the process of one embodiment of the invention.

FIG. 4 is another detailed flowchart of certain aspects of the process accordingly to an embodiment of the invention.

FIG. 5 is a rendering of a screenshot, which is encountered when using a software embodiment of the invention.

FIG. 6 is another screenshot encountered when using a specific software embodiment of the invention.

FIG. 7 is a software block diagram, which illustrates the process of analyzing existing group membership according to certain embodiments of the invention.

FIG. 8 is an additional detailed flowchart illustrating certain aspects of the process according to one embodiment of the invention.

FIG. 9 is a rendering of another screenshot, which might be encountered when using a software embodiment of the invention.

FIG. 10 is an additional screen shot rendering illustrating a screen that might be encountered when using a system according to embodiments of the invention.

### DETAILED DESCRIPTION

The present invention can be most readily understood by considering the detailed embodiments presented herein. Some of these embodiments are presented in the context of a large enterprise with computer resources distributed over a corporate intranet or local area network (LAN). These embodiments are examples only. The invention could be used to manage access to a variety of computer resources, all operating on a single server which is accessed via almost any means. Also, particularly with respect to screen shots, the embodiments are disclosed in the context of an organization with specific characteristics with respect to associates and organizational hierarchy. It cannot be over-emphasized that the invention has applicability to any type of organization and appropriate information for any such organization can be taken into account by a software tool implementing embodiments of the invention. Such information would be reflected in the actual user screens for a relevant embodiment.

The reader will be aided by an initial understanding of some of the terminology used in this disclosure. The terms computer resources and computing resources refer to software, objects, applications, as well as operating systems and the hardware that implements any or all of the foregoing which may be distributed throughout an enterprise. Thus, the term related computer resources and the like refers to a group of computer resources which is interconnected by a network or otherwise owned and managed by the same organization, for example, an enterprise or an information security organization within a large enterprise. Users of the various related computer resources in the disclosed embodiments are referred to as associates. These associates will typically be employees of an enterprise, however, the associates could also be contractors, executives, consultants, etc. The term associate is used to refer to these users in order to distinguish them from a person that may be referred to herein as a user, that is, the user of the tool that is implementing embodiments of the invention. Thus, according to its use through the remainder of this disclosure, the user is the person who is making use of the invention by directing the operation of a software tool on a server or computer platform in order to create profiles.

The terms profile, access profile, and the like refer to a role-based access profile as is understood in the art. A role-based access profile defines resource access based on a role. A role is typically defined in such a way that it relates to a job function within the organization using the invention, although this does not necessarily have to be the case. In an actual enterprise, a role might also be referred to as a job code or a job description or the like. Associates who are selected for analysis in order to allow a tool according to the invention to create a profile are referred to as model associates. These associates are simply associates that have been selected to model access rights for development of a potential role. Associates are selected from access groups, security groups or simply “groups.” Such a group is usually a list of users to which access is given for a specific computing resource in the traditional manner. For example, an access group might be defined to access the Email system. Another access group might be defined to access the accounting system, and so on. Terms such as hierarchy and related terms hierarchy codes and hierarchy code parameter refer to information about the organization of an enterprise making use of the invention. For example, information about divisions, business units, etc., as such would be specified in computerized records might be referred to as hierarchy code parameters. Other terms in this disclosure will either be discussed when introduced, or otherwise should be assumed to have the conventional meaning as understood by persons of ordinary skill in the art.

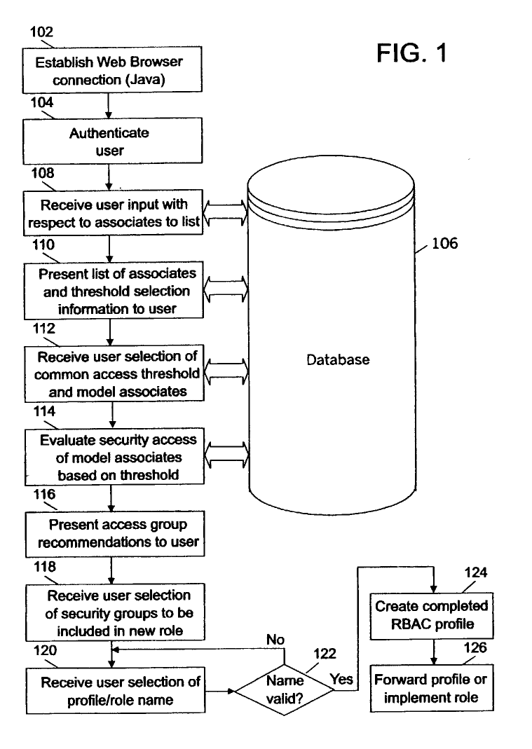

FIG. 1 is a flowchart, which explains the overall process of some embodiments of the invention. It is assumed for purpose of FIG. 1 that a user of a profile access selection system (PASS) according to the invention is accessing the PASS software tool on a server via an Intranet web connection. In some embodiments, it may be desirable to use a java script implementation of the invention. This connection between the user, at a client workstation, and the system is established at step 102. The user is then authenticated at step 104. This will typically involve a traditional user ID and password exchange. For the next several steps, and possibly even other steps, the system will interact with database 106, possibly via a Java applet. The database might be continually accessed and updated at various points throughout the process of creating an access profile. It is schematically shown as being accessed during specific steps for clarity. In the disclosed embodiments, this PASS database contains associate, organizational, and access group information necessary for the system to create profiles. It may also temporarily or permanently store tables and routines used by the system in the profile creation process.

At step 108, the user of the system inputs information with respect to associates to list as potential model associates. In the specific embodiment of this process disclosed here, this involves specifying hierarchy information such as hierarchy code parameters. However, in a small enterprise, this may simply involve an alphabetized search, or even requesting the display of all associates in the organization. The list of possible associates is presented at step 110. In the disclosed embodiments, a request for a commonality threshold is presented at the same time. These requests could be presented separately if the system were so designed. At step 112 the system receives a user selection of a common access threshold to use in producing the profile, and a user selection of model associates.

It would be useful at this time to discuss what is meant by a common access threshold. In the disclosed embodiments, this threshold is specified as a percent, however, it could be specified by other parameters, such as a raw number of associates that must meet a common access requirement. In any case this parameter represents the levels at which the system will compare associates access for commonality. For example, given a threshold specified as a percent, at 100%, the system will recommend access groups for profiles where all model associates have access to a given group. At a 90% threshold, nine of ten model associates must be members of the same access group for the system to recommend the group for inclusion in a profile. At 80%, eight of ten associates must have the access, etc. It might be said herein that according to the invention, profiles are created based on whether membership in a group at least meets a specific threshold or threshold value. By this terminology what is meant is that the system can be programmed to require common membership to meet or exceed the value, or simply to exceed the value, depending on the needs of the user or users.

Returning to FIG. 1, at step 114, the system performs an analysis of common access among model associates. At step 116, in the disclosed embodiments, the system will recommend security access groups to be included in the profile for the new, proposed role. At step 118, the user will select the groups to be included. This may involve adding or subtracting groups from a list of recommended groups, or simply approving the system's recommendations. It should also be noted that these steps are optional. A profile access selection system could be designed in which the results of the evaluation based on common access threshold are simply used to create the profile for a role without any further user interaction. At step 120, the user selects a name under which to store the profile or the role. At step 122, the validity of the name is checked. Certain names may not be permitted or the selected name may already be in use. If the name is not valid for any of these reasons, processing returns to the naming step for the user to try a different name. At step 124, the completed role-based access profile is created. This profile may simply be stored for later review, forwarded to a person or system for validation or review, or forwarded to a security administration system for immediate implementation. Which of these processes takes place depends on the needs of the organization using the invention, the size of the organization, and possibly even on the rights of the user to define roles within the organization.

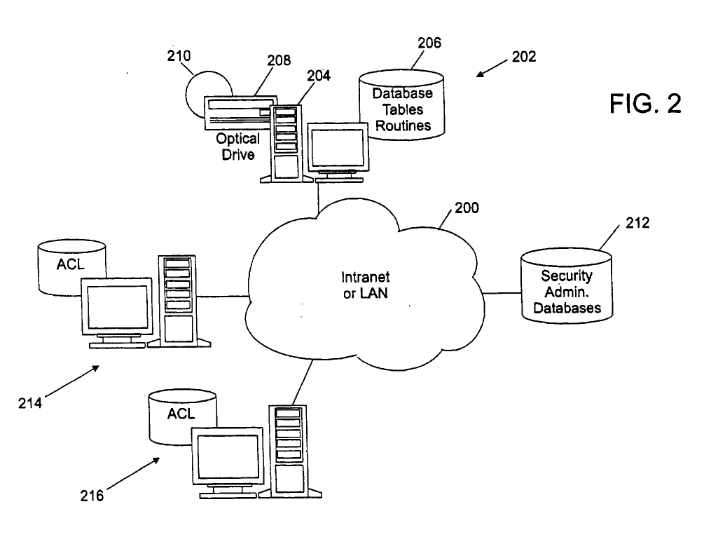

FIG. 2 illustrates a typical, network operating environment for the invention. In FIG. 2 various systems, servers, and other related computer resources are interconnected via a corporate Intranet or LAN 200. Profile access selection system 202 according to the present invention is connected to the network. This system includes a computer system or server 204, which in turn includes storage medium, illustrated graphically at 206, for storing the database of associate and group information, as well as any tables or routines that are needed for the invention to operate. In this particular example, an optical drive 208 is connected to the server for loading a computer program product on optical disk, 210, which includes a computer program with instructions for carrying out the methods of the invention. The database stored at 206 will typically be updated at regular intervals, possibly nightly, so that information regarding access groups is kept current. This update may be made from one or more security administration databases, 212, which track and control access rights throughout the enterprise. Alternatively, individual computing resources may provide updates to the database, for example, individual servers with access control lists as shown at 214 and 216. Such updates can be made in batch transactions or individual updates can be made every time a change occurs throughout any of the related computer resources. Any of the normal methods which are known in the art may be used to make these updates. For example, a push agent could be installed on the security administration databases or the individual resources in order to send updates to system 202. Alternatively, a pull agent may be installed in system 202 to request update information from the various computer resources on the network at regular intervals.

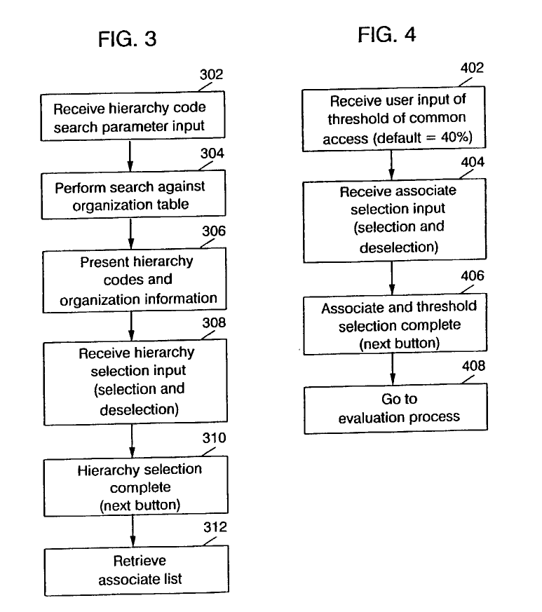

The remaining figures illustrate additional detail of the process disclosed by FIGS. 1 and 2 and the accompanying discussion. FIG. 3 illustrates one embodiment of the process of receiving user input and displaying selections with respect to choosing associates for use in creating profiles. In the embodiment of FIG. 3, associates are retrieved and displayed based on hierarchy code parameters. At step 302 a user enters one or more hierarchy code search parameters. The system then performs a search against an organization table at step 304. This organization table may be stored on the system implementing the profile access selection system or the organization table may be stored remotely. At step 306, the appropriate hierarchy information is presented to the user. In some embodiments, this presentation will be in the form of a list box of subcodes or organizations within a particular branch of the organization hierarchy. This presentation might also be keyed to the user's rights relative to the PASS tool. The system receives selection input from the user at step 308. This may be a process of selecting or deselecting specific hierarchy organizations recommended for use in creating profiles. In terms of a Java applet, this process may involve running an add hierarchy routine and a delete hierarchy routine each time the user makes a selection or deselection on the screen. Behind the scenes, the processing platform implementing such an embodiment is formulating a query that retrieves a list of associates. Typically the user will press a next button or take a similar action to end this process as shown at step 310. An inquiry is made to the database of associate information and a list of associates which can potentially serve as model associates will be retrieved and displayed at step 312. As previously mentioned, associates may be displayed and selected in any of various ways which will be familiar to those of ordinary skill in the art and therefore, will not be described in detail. These could include an alphabetical listing, a search routine which selected associates by entering partial names, or a simple display of all associates in the enterprise, possibly in the form of an alphabetized list.

FIG. 4 is a flowchart which depicts the process of selecting associates to be model associates, that is, associates whose group membership will be analyzed for commonality of access. In this embodiment, associate selection and a common threshold percentage are input at the same time, from the same screen. However, these two user inputs could be provided separately. Alternatively, a common access threshold could be programmatically determined internally to the PASS tool so that the user does not have a selection in this regard.

At step 402 the user selects a threshold of common access. In this embodiment this threshold is specified as a percentage, as previously discussed. Also in this embodiment, a default threshold is already specified. The user has the option of simply accepting the default threshold and not specifying a new threshold. At step 404, the system receives associate selection input from the user. In this embodiment, this input is received as a selection and deselection of associates which have been listed as a result of the searching steps previously discussed. It should be noted however, that the steps of accessing a list of associates and receiving a user selection of model associates could be reversed, or could be accomplished through a means that does not include a display of a list of associates. For example, associate's names could be input at a command line and the list of associates for potential use and modeling access rights could be accessed by the system, internally. In the embodiment where associates are selected and deselected from a list, routines within PASS and the client Java applet add associates and delete associates from a stored list. This process is similar to the process of selecting hierarchies as previously discussed.

At step 406, the associate and threshold selection in this embodiment is completed. As will be seen when the screen shots are discussed, the final selection is determined when the user hits a next button. At step 408, the system moves on to the analysis or evaluation process wherein common access is evaluated so that access groups may be selected or recommended for inclusion in the access profile.

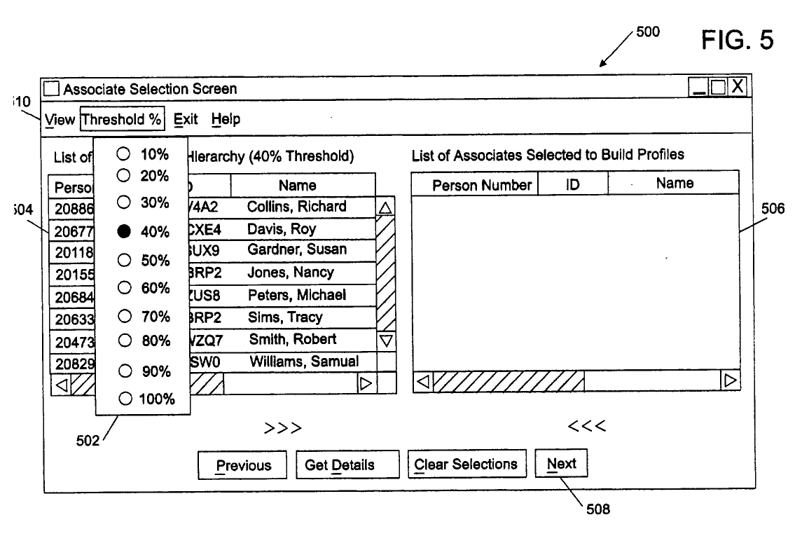

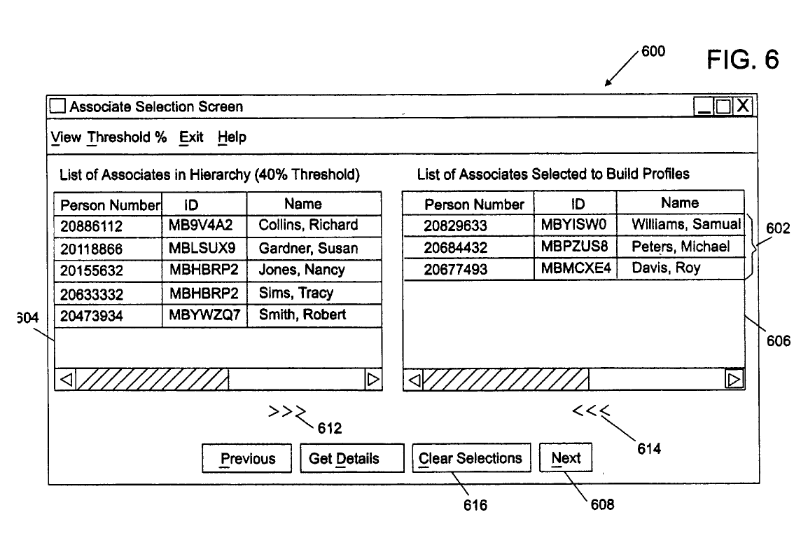

FIGS. 5 and 6 are screenshots, which illustrate how a user interacts with a software embodiment of the invention. Turning to FIG. 5, screen shot 500 includes drop down box 502 with radio buttons for selecting a threshold percentage. As previously discussed, the percentages represent the levels at which the PASS tool will compare associates' access for commonality. The default value 40% is preselected. Associates for potential use as model associates are listed in box 504. The typical frame controls for the Microsoft Windows™ operating system are present. Box 506 is where associates who are about to be chosen as model associates will be listed, once a user begins selecting associates from the list. Note that since no associates are listed in box 506, the next button, 508, is grayed out. In addition to the typical menu items present in the menu of this screen, a view menu, 510, presents various sort options, and also allows a user to hide or display columns of information about the associates. The workings of this view menu, as well as of other buttons not specifically discussed, are as is typical and known in the art and so no further explanation is required.

FIG. 6 illustrates how associates are initially selected and potentially deselected for use as model associates. Much of what is represented in the screen shot of FIG. 6 is the same as that in FIG. 5, and so will not be revisited. Note, however, that three associates have been preliminarily selected as model associates, as shown at 602 of screen 600. Note also that next button 608 is now no longer grayed out. A user can mouse click on an associate's name to select the associate for movement between the lists. A user can move a selected associate from box 604 to box 606 by pressing arrow button 612. Arrow button 612 moves all selected (highlighted) associates to the box of associates which will be finally selected to build profiles, 606. Likewise, associates can be deselected and/or moved the other way with arrow button 614. With the Java implementation illustrated here, a user can also select multiple associates with the mouse using the control and shift keys as is known in the art. Additionally, it is possible to create an implementation in which associates” names can be dragged between box 604 and box 606. If a user has highlighted a number of associates and then changes his or her mind, the clear selections button, 616, can be used to deselect a large number of associates. Otherwise, clicking the mouse on a highlighted associate will deselect that associate from the next move. If the lists in either box 604 and 606 become too long to fit in the viewable area, scroll bars will be formed along the sides of those boxes. The lists can be viewed by using the scroll bars in the normal fashion. When the user has finished building the list model associates to be used to build profiles, the user completes the process by hitting the next button, 608, which finally selects the associates listed on the right as model associates.

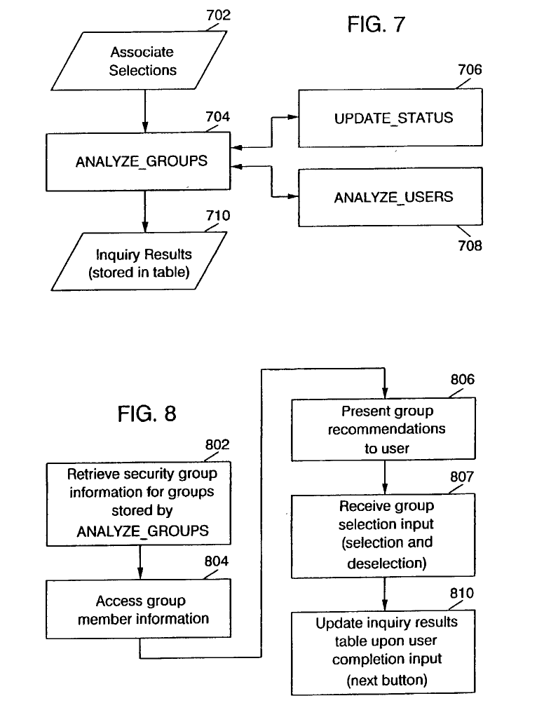

Once the next button is pressed in the above discussed screen, the PASS tool goes to work building profiles based on the common accesses of the associates chosen by the user. In some embodiments, a status box might be presented on the screen to display the steps in the analysis, progress, expected time to completion, etc. FIG. 7 is a block diagram illustrating the computer process routines involved in the analysis phase of some embodiments of the invention. FIG. 7 shows both certain aspects of flow as well as software blocks involved in the process. The associate selections, 702, discussed above, serve as input to the analyze groups routine, 704. Routine 704 communicates with update status routine 706 and analyze users routine 708. Routine 704 steps through all the various groups of which model associates are members. Inquiry results, 710, are output and stored in an inquiry results table. This table is continuously updated as the process proceeds. Routine 706 maintains the current status of the analysis by storing results in an inquiry number table. Results are stored with a time stamp to provide complete status information to the system for the case where a status box is presented to the user. The analyze users routine, 708, stores the common user access by access group name in a profile table. When access rights have been analyzed, the inquiry results table is updated a final time and a display is triggered of information regarding groups for inclusion in a profile.

FIG. 8 is a flowchart, which illustrates the process of presenting access group recommendations to the user. At step 802, security group information is retrieved. This security group information was stored by the analyze groups routine of FIG. 7. At step 804, the system retrieves and stores member information for the displayed groups so that the member information can be accessed by a user as desired. The handling of this information by a user will be discussed in further detail below. At step 806 the access group recommendations are presented to the user. This presentation allows the user to accept the recommendations made by the PASS tool or to modify the recommendations. A system could be devised which eliminates this step, simply building a profile based on the results of the analysis. At step 807, group selection input is optionally received from the user. In some embodiments, this input takes the form of initially selecting or deselecting access groups to be included in the profile. At step 810, user input is completed, for example, via a next button. This step finally selects the groups for the newly constructed access profile. In the example embodiment presented here, the inquiry results table is finally updated.

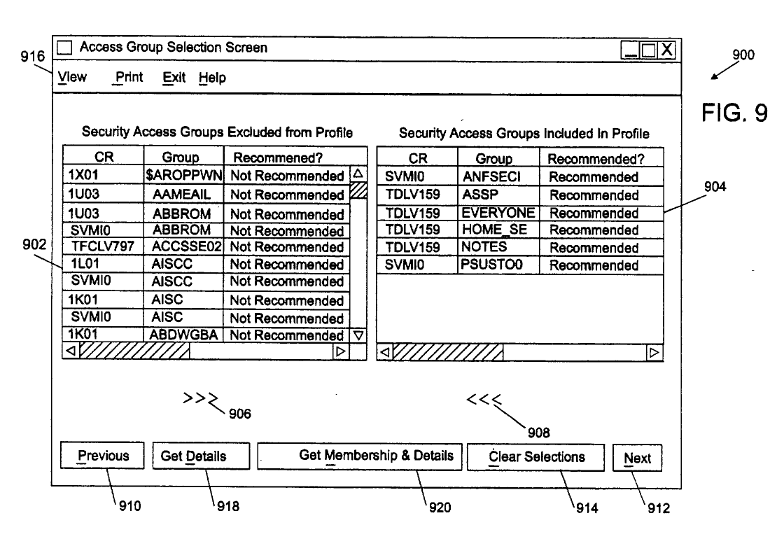

FIG. 9 is a screenshot, which illustrates the access group selection screen that is produced through the portion of the process illustrated in FIG. 8. This screen is similar to that shown for selecting model associates, as previously discussed with respect to FIGS. 5 and 6. Access selection screen 900 displays a large box 902 on the left-hand side. This box lists access groups with low percentages of common access relative to the threshold previously selected by the user. If the user makes no changes, these access groups will be excluded from the newly created access profile. Box 904, on the right-hand side of the screen, lists access groups that are recommended for inclusion in the profile being created. It is also possible that an existing role-based access profile would be listed in box 904. In this case, an already existing profile with one or more groups that would be recommended for the new profile has been created and can be subsumed into the new profile if the user wishes. The user can select individual or multiple groups for movement between the lists using standard input controls, as previously discussed with respect to the model associate selections. Excluded groups can be moved to the included group list with arrow button 906. Included groups can be moved to the excluded list with arrow button 908. Previous button 910 and next button 912 work as before. A clear selections button 914 is also present. The view menu item, 916, drops down a menu that allows showing or hiding columns in the boxes as well as sort options.

Note that the screen of FIG. 9 includes detail buttons. The get details button, 918, displays additional information about a highlighted group. This information might include number of members, a host name if applicable, the owner within the information technology organization, or other information. Note also that some information is already viewable in this example without pressing detail buttons, namely, the computing resource (CR) that each group is associated with. This information can be important in the event that the same group designation is used on more than one computing resource. In some embodiments, the details would include percentage commonality. This detail may be important if a user wishes to change the percentage threshold on the fly so to speak. The get membership and details button retrieves all of the same details as the get details button, but additionally retrieves a list of which associates are members of that access group. As previously mentioned, the user completes his or her final selection of access groups to be included in the new security access profile by clicking the next button 912. In many cases, a user-may wish to simply ratify the PASS tool's recommendations, meaning after viewing the screen, the user would simply hit the next button.

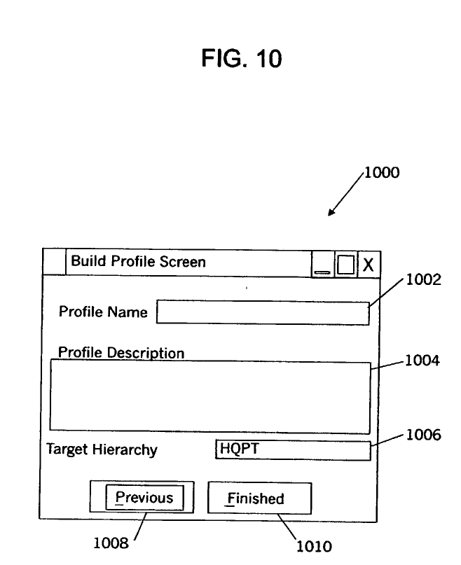

FIG. 10 illustrates a screen shot of the screen, 1000, that a user would encounter in naming a profile according to some embodiments of the invention. In screen 1000, the user enters a name for the profile in box 1002. A user then enters a profile description in box 1004. If applicable, a target hierarchy might be listed in box 1006. The target hierarchy would be listed, for example, when associates were selected based on hierarchy and all were from the same organization. This screen is provided with a previous button, 1008. When the user has finished entering information, he or she clicks the “finished” button 1010. The processing for this screen is illustrated in FIG. 1, where the validity of the name is checked. As previously discussed, the profile can simply be created and stored, created and forwarded, created and implemented, or some combination of the foregoing. Additionally, an option to print the profile might be presented. It should also be noted that if a profile is stored for later action, provisions can easily be made to return-to the profile for editing.

Note that the invention is typically implemented on a computing platform, workstation, instruction execution system, or the like, as illustrated at 204 of FIG. 2. Such a platform is typically controlled by a processor which serves as a central processing unit (CPU) for the platform. Memory and general purpose input/output (I/O) adapters are also present. These would include a network adapter, which connects the computing platform to a network as illustrated in FIG. 2. Computer program code instructions for implementing the profile access selection system are typically stored on some sort of fixed storage device such as a hard disk drive. Numerous types of general purpose computing systems and workstations are available and can be used to implement the invention. Available systems include those that run operating systems such as Windows™ by Microsoft, various versions of Unix, various versions of Linux, and various versions of Apple's Mac™ OS. The function of the invention, including the database, can be implemented in whole or in part on a single computing platform, or on multiple computing platforms connected by a network.

In any case, a computer program which implements parts of the invention through the use of a system like that illustrated in FIG. 2 can take the form of a computer program product residing on a computer usable or a computer readable storage medium, as illustrated at 210 of FIG. 2. A computer program product containing the program of instructions can be supplied in such a form, and loaded on the machines involved, either directly, or over a network. The medium may also be a stream of information being retrieved when the computer program product is “downloaded” through the Internet or a similar network. A computer program, as such, can reside on or in any medium that can contain, store, communicate, propagate, or transport the program for use by or in connection with any instruction execution system, apparatus, or device. A computer readable medium may be, for example, but not limited to, an electronic, magnetic, optical, electromagnetic, or semiconductor system, apparatus, or device. Note that the computer usable or computer readable medium could even be paper or another suitable medium upon which the program is printed, as the program can be electronically captured from the paper or other medium and then compiled, interpreted, or otherwise processed in a suitable manner.

Specific embodiments of an invention are described herein. One of ordinary skill in the computing and information security arts will quickly recognize that the invention has other applications in other environments. In fact, many embodiments and implementations are possible. The following claims are in no way intended to limit the scope of the invention to the specific embodiments described above. We claim:

1. A method of creating a role based access profile for a plurality of related computer resources, the method comprising:
accessing a list of associates for potential use in modeling potential access rights for a role;
receiving a user selection of model associates from the list of associates;
evaluating existing membership of the model associates in access groups related to the plurality of related computer resources; and
producing the access profile based on the existing membership of the model associates in the access groups, the access profile corresponding to the role.

2. The method of claim 1 wherein the evaluating of the existing membership of the model associates further comprises determining whether commonality of membership in an access group at least meets a specific threshold value.

3. The method of claim 2 wherein the specific threshold value is received as user input.

4. The method of claim 1 wherein the list of associates is accessed based on user input of at least one selection criteria and the receiving of the user selection of model associates is accomplished at least in part by presenting the list of associates to a user and receiving a user selection from the list.

5. The method of claim 4 wherein the at least one selection criteria comprises a hierarchy code parameter.

6. The method of claim 2 wherein the list of associates is accessed based on user input of at least one selection criteria and the receiving of the user selection of model associates is accomplished at least in part by presenting the list of associates to a user and receiving a user selection from the list.

7. The method of claim 6 wherein the at least one selection criteria comprises a hierarchy code parameter.

8. The method of claim 3 wherein the list of associates is accessed based on user input of at least one selection criteria and the receiving of the user selection of model associates is accomplished at least in part by presenting the list of associates to a user and receiving a user selection from the list.

9. The method of claim 8 wherein the at least one selection criteria comprises a hierarchy code parameter.

10. A computer program product comprising a computer program for creating role based access profiles for a plurality of related computer resources, the computer program further comprising:
instructions for accessing a list of associates for potential use in modeling potential access rights for a role;
instructions for receiving a user selection of model associates from the list of associates;
instructions for evaluating existing membership of the model associates in access groups related to the plurality of related computer resources; and
instructions for producing an access profile based on the existing membership of the model associates in the access groups, the access profile corresponding to the role.

11. The computer program product of claim 10 wherein the instructions for evaluating existing membership of the model associates further comprise instructions for determining whether commonality of membership in an access group at least meets a specific threshold value.

12. The computer program product of claim 11 wherein the specific threshold value is received as user input.

13. The computer program product of claim 10 wherein the list of associates is accessed based on user input of at least one selection criteria and the instructions for receiving the user selection of model associates further comprise instructions for presenting the list of associates to a user and receiving a user selection from the list.

14. The computer program product of claim 13 wherein the at least one selection criteria comprises a hierarchy code parameter.

15. The computer program product of claim 11 wherein the list of associates is accessed based on user input of at least one selection criteria and the instructions for receiving the user selection of model associates further comprise instructions for presenting the list of associates to a user and receiving a user selection from the list.

16. The computer program product of claim 15 wherein the at least one selection criteria comprises a hierarchy code parameter.

17. The computer program product of claim 12 wherein the list of associates is accessed based on user input of at least one selection criteria and the instructions for receiving the user selection of model associates further comprise instructions for presenting the list of associates to a user and receiving a user selection from the list.

18. The computer program product of claim 17 wherein the at least one selection criteria comprises a hierarchy code parameter.

19. Apparatus for creating role based access profiles for a plurality of related computer resources, the apparatus comprising:
means for accessing a list of associates for potential use in modeling potential access rights for a role;
means for receiving a user selection of model associates from the list of associates;
means for evaluating existing membership of the model associates in access groups related to the plurality of related computer resources; and
means for producing an access profile based on the existing membership of the model associates in the access groups, the access profile corresponding to the role.

20. The apparatus of claim 19 further comprising means for receiving user input of a threshold value for use in evaluating existing membership of the model associates in access groups related to the plurality of related computer resources.

21. The apparatus of claim 19 further comprising means for implementing the role based on the access profile.

22. The apparatus of claim 20 further comprising means for implementing the role based on the access profile.

23. A system for creating role based access profiles for a plurality of related computer resources, the system comprising:
a database of access group information for the plurality of relate computer resources; and
a processing platform operatively connected to the database, the processing platform operable to cause the system to access the database, receive a user selection of model associates, and evaluate existing membership of the model associates in access groups to produce the role based access profile.

24. The system of claim 23 further comprising a network connection for updating the database.

25. The system of claim 24 wherein the system is further operable to forward the role based access profile over the network connection.

26. The system of claim 24 wherein the database further comprises hierarchy information.

27. The system of claim 23 wherein evaluating existing membership of the model associates in an access group is accomplished at least in part by determining whether commonality of membership in the access group at least meets a specific threshold value.

28. The system of claim 27 wherein the specific threshold value is received as user input.

29. The system of claim 24 wherein evaluating existing membership of the model associates in an access group is accomplished at least in part by determining whether commonality of membership in the access group at least meets a specific threshold value.

30. The system of claim 29 wherein the specific threshold value is received as user input.

31. The system of claim 25 wherein evaluating existing membership of the model associates in an access group is accomplished at least in part by determining whether commonality of membership in the access group at least meets a specific threshold value.

32. The system of claim 31 wherein the specific threshold value is received as user input.

33. The system of claim 26 wherein evaluating existing membership of the model associates in an access group is accomplished at least in part by determining whether commonality of membership in the access group at least meets a specific threshold value.

34. The system of claim 33 wherein the specific threshold value is received as user input.
